(19) United States
(12) Patent Application Publication
(10) Pub. No.: US 2012/0331448 A1
(43) Pub. Date: Dec. 27, 2012

(54) COVERAGE MEASUREMENT APPARATUS AND METHOD AND MEDIUM

(75) Inventors: Hiroaki Tanaka, Kanagawa (JP); Takashi Miura, Kanagawa (JP)

(73) Assignee: KABUSHIKI KAISHA TOSHIBA, Tokyo (JP)

(21) Appl. No.: 13/238,660

(22) Filed: Sep. 21, 2011

(30) Foreign Application Priority Data
Jun. 27, 2011 (JP) 2011-141671

(51) Int. Cl. G06F 9/44

(52) U.S. Cl. 717/127

(57) ABSTRACT

According to one embodiment, a coverage measurement apparatus includes a compiler unit, an execution environment unit, and a coverage calculation unit. The compiler unit produces a first object code from a program to be subjected to coverage measurement, and inserts an instruction to switch to a code rewriting process into the first object code, the code rewriting process being such that when the instruction is executed, the instruction is rewritten into a no-operation instruction. The execution environment unit executes the first object code, thereby producing a second object code. The coverage calculation unit calculates, based on the first and second object codes, the coverage of the program to be subjected to the coverage measurement.

### CROSS-REFERENCE TO RELATED APPLICATIONS

This application is based upon and claims the benefit of priority from Japanese Patent Application No. 2011-141671, filed on Jun. 27, 2011; the entire contents of which are incorporated herein by reference.

### FIELD

Embodiments described herein relate generally to a coverage measurement apparatus and method and a medium.

### BACKGROUND

One of the known methods for measuring the coverage of a program by executing the program on an actual processor, involves inserting into a target program an instrumentation code for obtaining the coverage, and collecting coverage information when executing the program. An instrumentation code generally refers to a code for recording in a memory passage through a certain location on a source code. Instrumentation codes are embedded in various places in a program, records resulting from execution at these places are collected to determine the places executed in the program, and thus the coverage of the program is measured.

One example of a coverage measurement tool is “gcov” in which, when a compiler program is executed, an instrumentation code is embedded in a program to be subjected to coverage measurement. Instrumentation codes embedded by “gcov” collect a variety of information such as whether each line of a program has been passed and the number of times that it has been passed.

### BRIEF DESCRIPTION OF THE DRAWINGS

FIG. 1 is a diagram illustrating a configuration of the coverage measurement apparatus according to a first embodiment;

FIG. 2 is a diagram illustrating an example of a hardware configuration for a coverage measurement apparatus according to the first embodiment;

FIG. 3 is a flowchart illustrating the entire coverage measurement method according to the first embodiment;

FIG. 4 is a flowchart illustrating a compiling process;

FIG. 5 is a diagram illustrating the concept of instrumentation code insertion according to the first embodiment;

FIG. 6 is a diagram illustrating the concept of the instrumentation code table 23 according to the first embodiment;

FIG. 7 is a flowchart illustrating a process performed by an interruption handler;

FIG. 8 is a diagram illustrating the concept of the process performed by the interruption handler;

FIG. 9 is a flowchart illustrating a coverage calculation process;

FIG. 10 is a diagram illustrating the concept of the coverage calculation process;

FIG. 11A is a diagram illustrating a display example of a coverage measurement result;

FIG. 11B is a diagram illustrating another display example of a coverage measurement result;

FIG. 12 is a flowchart illustrating a compiling process according to a second embodiment; and

FIG. 13 is a diagram illustrating the concept of instrumentation code insertion according to the second embodiment.

### DETAILED DESCRIPTION

According to the embodiments, a coverage measurement apparatus includes a compiler unit, an execution environment unit, and a coverage calculation unit. The compiler unit produces a first object code from a program to be subjected to coverage measurement, and inserts an instruction to switch to a code rewriting process into the first object code, the code rewriting process being such that when the instruction is executed, the instruction is rewritten into a no-operation instruction. The execution environment unit executes the first object code, thereby producing a second object code. The coverage calculation unit calculates, based on the first and second object codes, the coverage of the program to be subjected to the coverage measurement.

Exemplary embodiments of the coverage measurement apparatus and method and the medium will be explained below in detail with reference to the accompanying drawings. The present invention is not limited to the following embodiments.

First, the characteristics of the first embodiment of the present invention will be described schematically.

In the first embodiment, instrumentation codes are inserted into a program to be subjected to coverage measurement, and the program is executed by a target processor. Upon executing the instrumentation codes embedded in the program, the target processor rewrites the point where each instrumentation code in the program being executed is embedded, and thereby the processor nullifies the instrumentation code so that even when this point is next executed, the same instrumentation code is not invoked. After execution of this program, the programs before and after execution are compared in terms of the location at which the instrumentation code is inserted, thereby obtaining coverage measurement as a result. Specifically, if there is any change at the point in the program where the instrumentation code is inserted before and after the execution, it is determined that the point has been passed through during the program execution, and if there is no change, it is determined that the point has not been passed through. The results from all those points determined whether they have been passed through are totaled to measure the coverage of the programs.

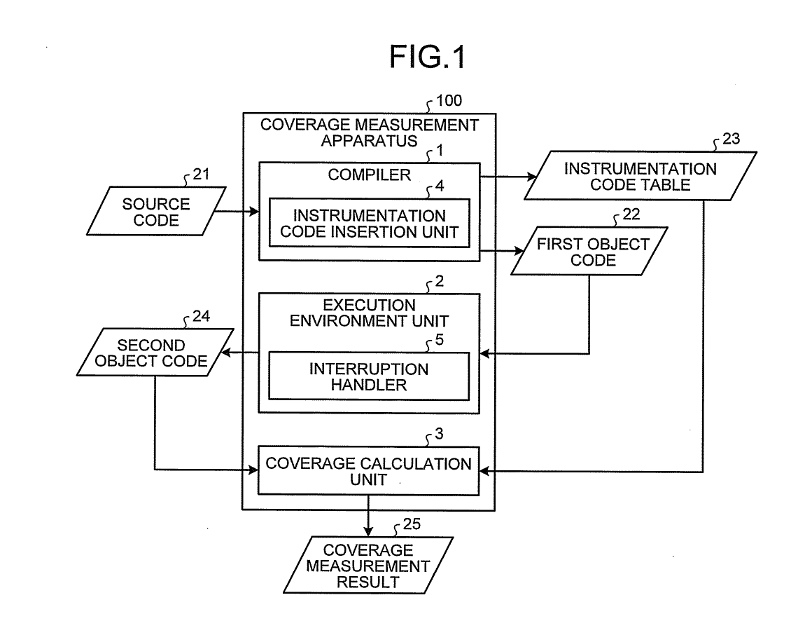

FIG. 1 is a diagram illustrating a configuration of the coverage measurement apparatus according to the first embodiment. The coverage measurement apparatus 100 includes a compiler (compiler unit) 1, an execution environment unit 2, and a coverage calculation unit 3.

The compiler 1 receives as input a source code 21 written in a high-level general-purpose language, which is a program to be subjected to coverage measurement. The compiler 1 converts the input source code 21 into a first object code 22 executable by a target processor. The compiler 1 incorporates an instrumentation code insertion unit 4 for embedding instrumentation codes (which are instructions to break current program execution and switch to a′ code rewriting step) into the first object code 22. In addition, the compiler 1 outputs information about the inserted instrumentation codes to an instrumentation code table 23.

The execution environment unit 2 functions as an execution environment for a program to be subjected to coverage measurement. The unit 2 has a memory area for storing the first object code 22, and a target processor for executing the first object code 22 stored in this memory area. The execution environment unit 2 may be a simulator or an actual machine such as a processor system.

The execution environment unit 2 incorporates an interruption handler 5 configured such that, when each instrumentation code is executed, this executed instrumentation code is nullified. The interruption handler 5 nullifies a corresponding instrumentation code for the first object code 22 during execution of the first object code 22. Therefore, after execution of the first object code 22, the execution environment unit 2 produces a second object code 24 in which the executed instrumentation code is nullified.

To execute the first object code 22, the execution environment unit 2 has to be set so that each instrumentation code in the first object code 22 is rewritable. For example, the first object code 22 must be stored in a rewritable memory, such as a RAM (Random Access Memory). When a processor or memory incorporates the function of preventing a program from being rewritten, the function must be nullified.

The coverage calculation unit 3 compares the first object code 22 and second object code 24, thereby obtaining the coverage of the source code 21, and outputs it as a coverage measurement result 25. To be more specific, among instrumentation codes contained in the first object code 22, the coverage calculation unit 3 separately totals remaining non-nullified codes and nullified codes in the second object code 24, and calculates the coverage.

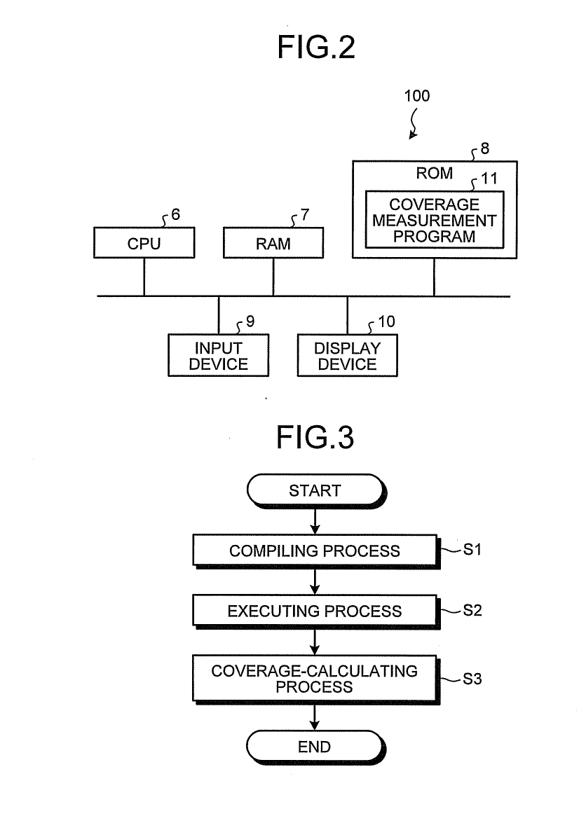

FIG. 2 is a diagram illustrating an example of a hardware configuration for a coverage measurement apparatus according to the first embodiment. The coverage measurement apparatus 100 includes a CPU (Central Processing Unit) 6, RAM 7, ROM (Read Only Memory) 8, input device 9, and display device 10. They are connected to one another via a bus.

In the ROM 8 serving as a recording medium, a coverage measurement program 11 is recorded for realizing the coverage measurement apparatus according to the first embodiment. Using the RAM 7 as a work area, the CPU 6 executes a coverage measurement program 11. The display device 10 is, for example, a liquid crystal monitor, which displays output information, such as an operating screen, for a user. The input device 9 includes, a mouse, keyboard, etc., and receives operation input by a user. Operation information input through the input device 9 is transmitted to the CPU 6.

The coverage measurement program 11 has a module function that includes the compiler 1, execution environment unit 2, coverage-calculating unit 3, instrumentation code insertion unit 4, and interruption handler 5. The coverage measurement program 11 is loaded in the RAM 7, thereby realizing the coverage measurement apparatus 100. Instead of the foregoing, the configuration may be such that the coverage measurement program 11 does not include a module that realizes the complier 1, but the module of the instrumentation code insertion unit 4 for the coverage measurement program 11 may be installed in a generally available compiler. Equally, the configuration may be such that the coverage measurement program 11 does not include the execution environment unit 2, but a module for the interruption handler 5 for the coverage measurement program 11 may be installed in a separately prepared actual machine or a separately formed simulator.

The coverage measurement program 11 is loaded in the RAM 7 from the ROM 8 via the bus. The CPU 6 executes the coverage measurement program 11 loaded in the RAM 7. Thus, the first object code 22, second object code 24, and coverage measurement result 25 are produced for the source code 21 input from an external storage device or the like. The first object code 22, second object code 24, and coverage measurement result 25 are temporarily stored in a data storage area provided in the RAM 7. The coverage measurement result 25 is formed into image data for display use and then output to the display device 10.

The coverage measurement program 11 may be stored in a recording medium such as a CD-ROM or external storage device. In addition, the coverage measurement program 11 may be provided or distributed by its being stored in a recording medium on a computer connected to a network such as the Internet, and by its being downloaded via the network.

Next, a coverage measurement method according to the first embodiment realized by the coverage measurement apparatus 100 will be described using a specific example of code.

FIG. 3 is a flowchart illustrating the coverage measurement method according to the first embodiment. Upon input of a source code 21 to be subjected to coverage measurement, the source code 21 is compiled (compiling process, S1). Subsequently, a first object code 22 is executed to produce a second object code 24 (executing process, S2). Then, based on the first and second object codes 22 and 24, coverage is calculated (coverage-calculating process S3).

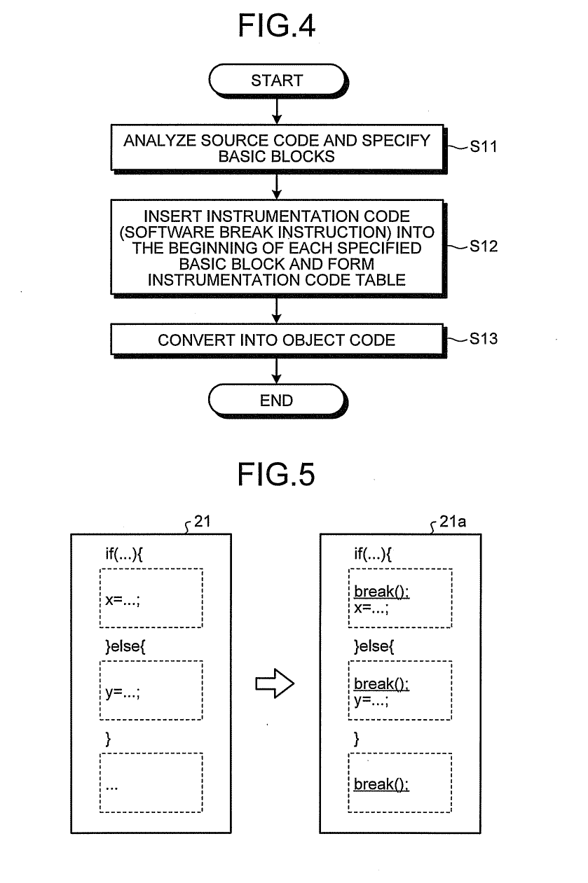

FIG. 4 is a flowchart illustrating the compiling process (S1). Upon input of the source code 21, the instrumentation code insertion unit 4 analyzes the source code 21, and specifies basic blocks in the source code 21 (S11). The basic block refers to continuous lines of code that have no branches, that is, the lines between the branches and junctions in a program. Specifying a branch and a junction can specify a basic block.

Subsequently, the instrumentation code insertion unit 4 inserts instrumentation codes into each of specified basic blocks, and forms an instrumentation code table 23 that illustrates locations at which instrumentation codes are inserted (S12). In the first embodiment, for example, line coverage is measured. In order to measure the line coverage, a determination has to be made whether any one point in a line of code in the program has been executed or not when a target processor executes a program. If it is found that any one of the points in the line of code in each basic block has been executed, it means that it has been determined that all the lines of code composing the basic block have been executed. Therefore, in the process S12, one instrumentation code is inserted in each of the basic blocks. Incidentally, the number of instrumentation codes inserted in each basic block is not limited in particular. However, overheads required for an interruption process may increase with the number of instrumentation codes and, accordingly, the preferable number of instrumentation codes inserted in each basic block is one. In addition, while inserting instrumentation codes, the instrumentation code insertion unit 4 records code insertion points in an instrumentation code table 23 for calculation of coverage. Recorded in the instrumentation code table 23 are the locations of the instrumentation codes in the object, and the file and line of corresponding source codes.

FIG. 5 is a diagram illustrating the concept of instrumentation code insertion according to the first embodiment. A source code 21a illustrates a source code after instrumentation code insertion. The source code 21 has three basic blocks indicated by broken lines. In the source code 21a, [break ( )], which represents an instrumentation code, is inserted in each basic block. Each [break ( )] refers to a software break instruction that causes an interruption process when execution is underway. Due to the software break instruction, control shifts from a target program for the coverage measurement to the interruption handler 5. When control shifts to the interruption handler 5, a memory records the address where the instruction has caused the software interruption. The interruption handler 5 is able to read this memory address.

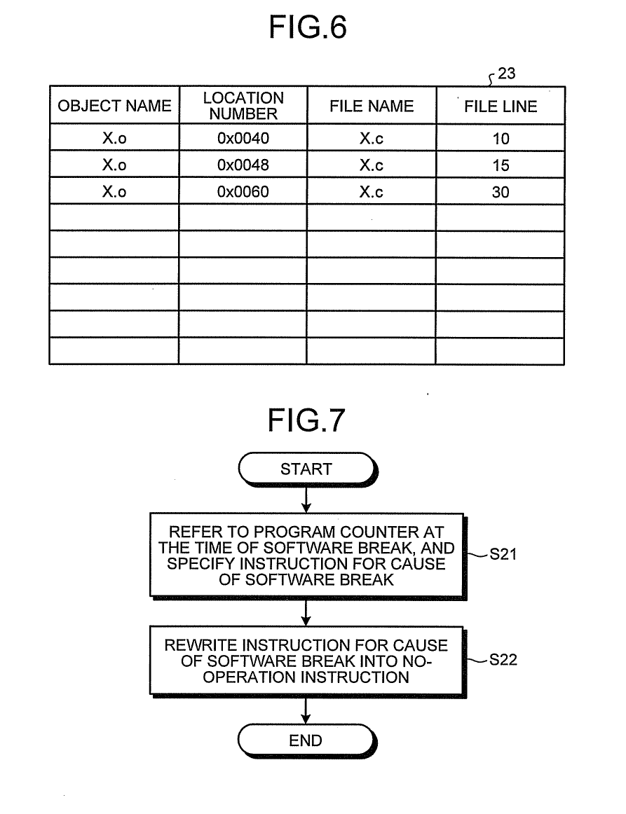

FIG. 6 is a diagram illustrating the concept of the instrumentation code table 23 according to the first embodiment. The instrumentation code table 23 includes the following items: object name, location number, file name, and file line. The one line of items is described for each instrumentation code. The object name refers to the name of a first object. The location number refers to the address where the instrumentation code is disposed in the RAM 7. The file name refers to the name of a source code. The file line refers to a line in the source code. The instrumentation code table 23 makes it possible to determine the number of instrumentation codes inserted in the object and their locations. Checking the locations of instrumentation code insertion in the second object makes it possible to calculate coverage.

After instrumentation code insertion, the compiler 1 compiles the source code after instrumentation code insertion, thereby producing the first object code 22 (S13), and terminates the compiling process.

For ease of understanding, the description above was given using an example where the first object code 22 is produced by inserting instrumentation codes into the source code 21 and then compiling the source code 21 in which the instrumentation codes have been inserted. However, the instrumentation codes may be inserted after conversion into assembly or object code.

When each instrumentation code [break ( )] is executed during the execution process (S2) of the execution environment unit 2, control switches to the interruption handler 5 due to software interruption. FIG. 7 is a flowchart illustrating the process performed by the interruption handler 5. If interruption occurs during the execution process, the interruption handler 5 refers to a program counter at the time of the interruption, and gives an instruction for the cause of this interruption, that is, specifies the point in the executed instrumentation code (S21). Then, the interruption handler 5 rewrites the specified instrumentation code into a no-operation instruction (S22). When the rewriting process performed by the interruption handler 5 finishes, control returns to the point controlled before the interruption of the first object code 22.

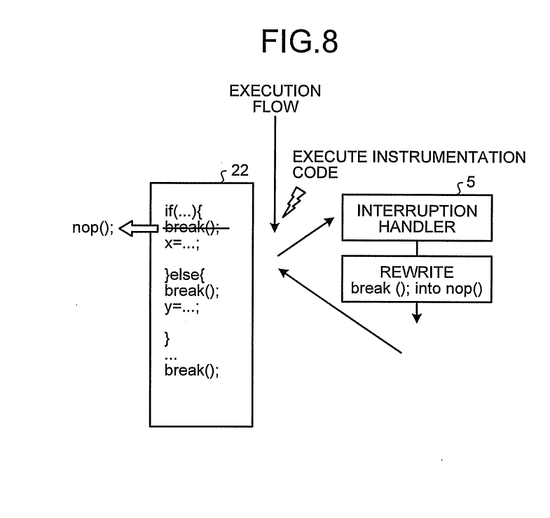

FIG. 8 is a diagram illustrating the concept of the process performed by the interruption handler 5. When [break ( )] contained in the first object code 22 being executed is performed, interruption occurs, and the interruption handler 5 rewrites the [break ( )] that was the cause of the interruption into a no-operation instruction [nop ( )]. By rewriting the [break ( )] in the manner described above, the interruption handler 5 prevents interruption from occurring when the same basic block is executed again.

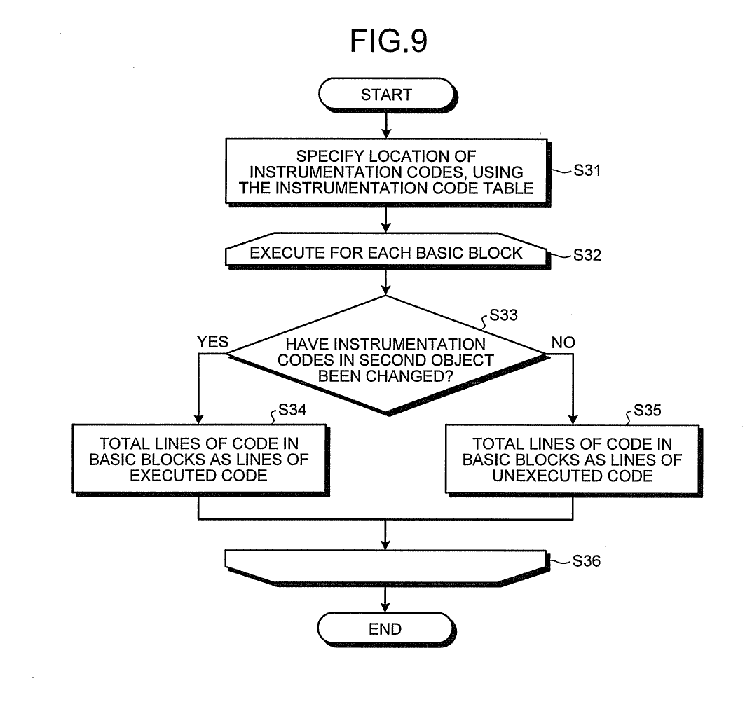

FIG. 9 is a flowchart illustrating the coverage calculation process (S3). When the entire execution process terminates, the coverage calculation unit 3 specifies instrumentation codes in basic blocks, using the instrumentation code table 23 (S31). Then, the coverage calculation unit 3 performs a loop process from S32 to S36 for each of the basic blocks, and terminates this coverage calculation process. In the second object code 24 compared with the first object code 22, the instrumentation code disposed in each of the executed basic blocks has been rewritten into a non-calculation instruction. The coverage calculation unit 3 determines whether the instrumentation code in each basic block has been rewritten from the first object code 22 to the second object code 24 (step S33). If the rewriting has taken place (Yes in S33), the coverage calculation unit 3 totals lines of code in the basic blocks as lines of executed code (step S34). If the rewriting has not taken place (No in S33), the coverage calculation unit 3 totals lines of code in the basic blocks as lines of unexecuted code (S35). The executed lines and the unexecuted lines are separately totaled, and the results of these totals are output as a coverage measurement result 25.

In this case, the lines of executed code and the lines of unexecuted code are separately totaled. However, the total of instrumentation codes can be found by referring to the instrumentation code table 23. Therefore, either the lines of executed code or the lines of unexecuted code may be totaled and the other may be calculated from the total of the instrumentation codes.

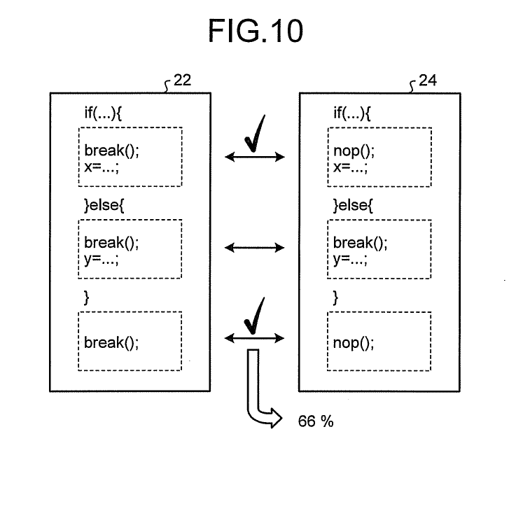

FIG. 10 is a diagram illustrating the concept of the coverage calculation process. In FIG. 10, two of three [break ( )]s inserted in the first object code are rewritten into [nop ( )]. In this case, if it is assumed that the three basic blocks are equal in the numbers of lines of code, a line coverage measurement result 25 is 66%.

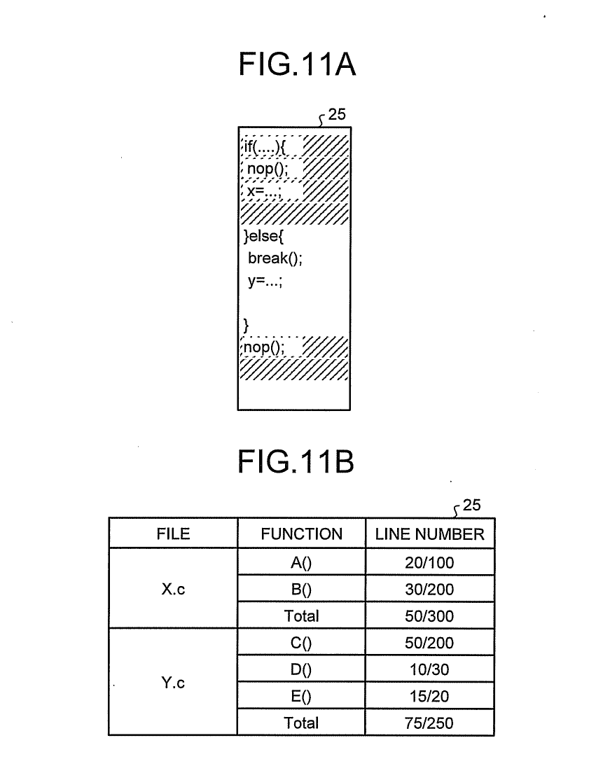

FIG. 11 is a diagram illustrating a display example of the coverage measurement result 25. FIG. 11A is an example of the coverage measurement result 25 where lines of code described in the source code 21 are illustrated such that code in the lines which has been determined to have been executed by the coverage calculation process can be identified by its being displayed in color. By displaying the source code in color in that manner, coverage can be checked at a glance. FIG. 11B is an example of the configuration of a table in which the number of lines executed is described for each file and each function with respect to the coverage measurement result 25. Thus, by displaying them in units differing according to coverage target, the coverage at a point on which attention is more focused can be determined.

In the foregoing, a description was given using an example where the interruption handler 5 rewrites each instrumentation code contained in the first object code. However, the first object code 22 may include an embedded program in which the instrumentation code insertion unit 4 is invoked by an instrumentation code and may rewrite this invoked instrumentation code. This configuration eliminates the need for the execution environment unit 2 to mount the interruption handler 5. Accordingly, the execution environment unit 2 can rewrite the instrumentation code simply by executing the first object code 22.

Additionally, the instrumentation code insertion unit 4 outputs a source code in which instrumentation codes are inserted. When rewriting the instrumentation codes of the first object code 22, the interruption handler 5 also may rewrite the instrumentation codes corresponding to the source code into no-operation instructions. The coverage calculating section 3 may output a source code before and after the rewriting of the instrumentation codes together with the coverage measurement result 25.

The coverage calculation unit 3 indirectly compares the first and second object codes 22 and 24 by using the instrumentation code table 23. However, it may directly compare the first and second object codes 22 and 24.

As described above, an instrumentation code insertion unit 4 configured to, when a first object code 22 is produced from a source code 21 to be subjected to coverage measurement, insert an instrumentation code for rewriting the instrumentation code into no-operation instructions into the first object code 22 on execution of the instrumentation code; an execution environment unit 2 configured to execute the produced first object code 22; and a coverage calculation unit 3 configured to calculate coverage of the source code 21 based on the no-operation instruction and an instrumentation code contained in a second object code 24 output by the execution environment unit 2. Accordingly, the first embodiment prevents the once executed instrumentation code from being executed again, and hence shortens the time required for coverage measurement.

In addition, the instrumentation code insertion unit 4 specifies basic blocks of the source code 21 and inserts one instrumentation code into each of the specified basic blocks. Accordingly, line coverage can be measured efficiently. Specifically, since one instrumentation code is inserted per basic block, coverage can be measured efficiently with less computation.

Additionally, the coverage calculation unit 3 totals basic blocks, in the second object code 24, in which instrumentation codes remain, as unexecuted basic blocks. Alternatively, the coverage calculation unit 3 totals basic blocks in which instrumentation codes are rewritten into no-operation instructions, as executed basic blocks. Based on the result of the total, this unit 3 calculates the coverage. Accordingly, line coverage can be measured efficiently.

A second embodiment enables measurement of branch coverage. The coverage measurement apparatus according to the second embodiment is realized by the same configuration as that in the first embodiment. The functional components of the coverage measurement apparatus according to the second embodiment are substantially identical to those in the first embodiment, except the operation of the instrumentation code insertion unit 4. Only descriptions different from those in the first embodiment will be given below, and duplicated descriptions are not repeated here.

A branch coverage refers to one corresponding to a branch in a program. In order to measure a branch coverage, it is necessary to specify a point of execution between the lines of code, instead of a point of execution in lines of code as in the line coverage. Because of this, the instrumentation code insertion unit 4 inserts an instrumentation code into a branch section in a program.

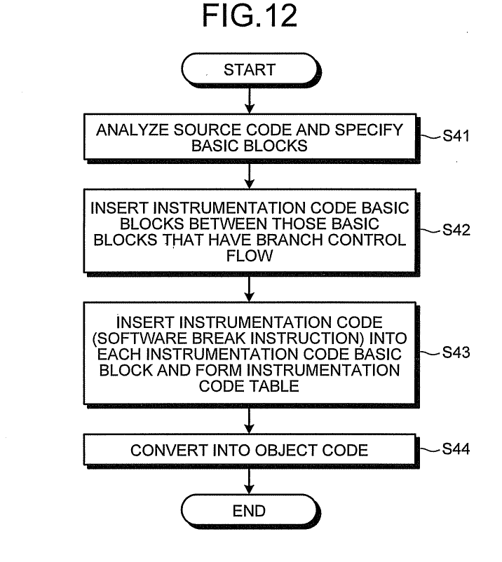

FIG. 12 is a flowchart illustrating a compiling process according to the second embodiment. Upon input of a source code 21, the instrumentation code insertion unit 4 analyzes a source code 21 and specifies basic blocks in the source code 21 (S41). Then, the instrumentation code insertion unit 4 specifies the basic block from which the branch starts and the block at which the branch ends with respect to the branch in the source code 21, and inserts additional instrumentation code basic blocks between those basic blocks (S42). Then, the instrumentation code insertion unit 4 inserts an instrumentation code (i.e., a instruction to switch to a code rewriting process) into each of the additional instrumentation code basic blocks, and forms an instrumentation code table 23 indicating the location in which the instrumentation codes are inserted (S43). After the insertion of the instrumentation codes, the compiler 1 compiles the source code subjected to the insertion of the instrumentation codes, and thereby produces a first object code 22 (S44). Then, the compiling process ends.

Thereafter, the first object code 22 is executed in the same way as the first embodiment, thereby producing the second object code 24. The first and second object codes 22 and 24 are analyzed and the coverage is measured.

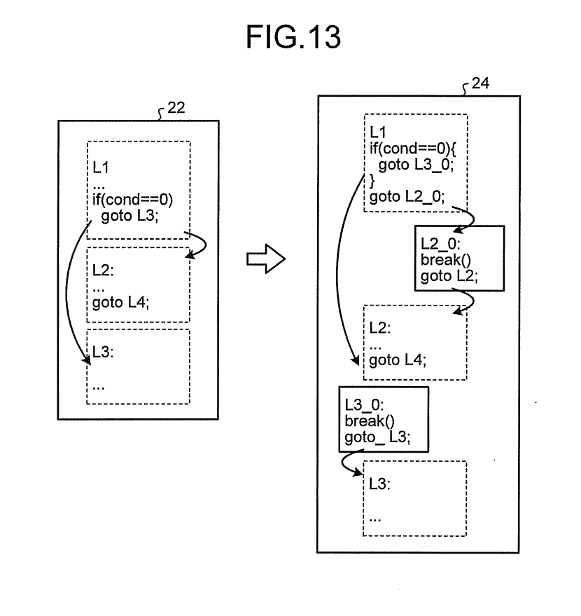

FIG. 13 is a diagram illustrating the concept of instrumentation code insertion according to the second embodiment. Lines of code, surrounded by broken lines, form a basic block contained in the first object code 22. Lines of code surrounded by solid lines illustrate instrumentation code basic blocks. As illustrated in FIG. 13, additional basic blocks are inserted into a branch between the basic blocks, that is, between L1 and L2 and between L1 and L3. The instrumentation codes [break ( )] are inserted between these additional basic blocks.

As described above, in the second embodiment, the compiler 1 is configured to specify the basic blocks of the source code 21, and inserts basic blocks with instrumentation codes inserted in them, into a branch section between those specified basic blocks. Accordingly, branch coverage can be measured efficiently. The second embodiment, similarly to the first embodiment, may prevent once executed instrumentation code from being executed again. Accordingly, the time required for coverage measurement may be shortened.

Additionally, among the basic blocks included in the second object code 24, the coverage calculation unit 3 totals basic blocks in which instrumentation codes remain, as unexecuted basic blocks. Alternatively, the coverage calculation unit 3 totals basic blocks in which instrumentation codes are rewritten into no-operation instructions, as executed basic blocks. Based on the result of the total, this unit 3 calculates the coverage. Accordingly, branch coverage can be measured efficiently.

In the second embodiment, a description was given using [break ( )] as an example of an instrumentation code to be rewritten. However, a code rewriting process may use a regular function, and an instrumentation code may be an instruction to invoke the function. In addition, a description was given using [nop ( )] as an example of an instrumentation code resulting from rewriting. However, an instrumentation code may be rewritten into a code that has substantially the same effect as [nop ( )] (e.g., an instruction to perform a calculation for nothing, such as adding zero).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A coverage measurement apparatus comprising:
a compiler unit configured to produce a first object code from a program to be subjected to coverage measurement, and to insert, into the first object code, a control switch instruction to switch, when the control switch instruction is executed, to a code rewriting process which rewrite the control switch instruction into a no-operation instruction;
an execution environment unit configured to execute the first object code, thereby to produce a second object code; and
a coverage calculation unit configured to calculate, based on the first and second object codes, a coverage of the program to be subjected to the coverage measurement.

2. The apparatus according to claim 1, wherein the coverage calculation unit calculates the coverage by comparing the first and second object codes.

3. The apparatus according to claim 1, wherein the control switch instruction is a software break instruction, and wherein the execution environment unit includes an interruption processing unit configured to perform an interruption process based on the inserted software break instruction and to rewrite the software break instruction that has caused the interruption process into the no-operation instruction.

4. The apparatus according to claim 1, wherein the compiler unit specifies basic blocks of a source code of the program, and inserts the switch instruction into each specified basic block.

5. The apparatus according to claim 4, wherein the coverage calculation unit totals basic blocks, contained in the second object code, in which the control switch instruction remains, as unexecuted basic blocks, or totals basic blocks in which the control switch instruction is rewritten into the no-operation instruction, as executed basic blocks, and calculates the coverage based on the result of the total.

6. The apparatus according to claim 1, wherein the compiler unit specifies a basic block from which a branch starts of a source code of the program and a basic block at which the branch ends of the source code, and inserts a basic block containing the control switch instruction to switch into the branch section between the specified basic blocks.

7. The apparatus according to claim 6, wherein the coverage calculation unit totals basic blocks, contained in the second object code, in which the control switch instruction remains, as unexecuted basic blocks, or totals basic blocks in which the control switch instruction is rewritten into the no-operation instruction, as executed basic blocks, and calculates the coverage based on the result of the total.

8. A coverage measurement method comprising:
producing a first object code from a program to be subjected to coverage measurement, and inserting, into the first object code, a control switch instruction to switch, when the switch instruction is executed, to a code rewriting process which rewrite the control switch instruction into a no-operation instruction;
executing the first object code, thereby to produce a second object code; and
calculating, based on the first and second object codes, a coverage of the program to be subjected to the coverage measurement.

9. The method according to claim 8, wherein calculating the coverage includes comparing the first and second object codes.

10. The method according to claim 8, wherein the control switch instruction is a software break instruction, and wherein when the first object code is executed, an interruption process based on the inserted software break instruction is executed, and the software break instruction that has caused the interruption process is rewritten into the no-operation instruction.

11. The method according to claim 8, wherein producing the first object code includes specifying basic blocks of a source code of the program, and inserting the control switch instruction into each specified basic block.

12. The method according to claim 11, wherein calculating the coverage includes totaling the basic blocks, contained in the second object code, in which the control switch instruction remains, as unexecuted basic blocks, or totaling the basic blocks in which the control switch instruction is rewritten into the no-operation instruction, as executed basic blocks, and calculating the coverage based on the result of the total.

13. The method according to claim 8, wherein producing first object code includes specifying a basic block from which a branch starts of a source code of the program and a basic block at which the branch ends of the source code, and inserting basic blocks containing the control switch instruction to switch in the branch section between the specified basic blocks.

14. The method according to claim 13, wherein calculating the coverage includes totaling the basic blocks, contained in the second object code, in which the control switch instruction remains, as unexecuted basic blocks, or totaling the basic blocks in which the control switch instruction is rewritten into the no-operation instructions, as executed basic blocks, and calculating the coverage based on the result of the total.

15. A computer readable medium comprising a plurality of instructions that cause a computer to:
insert a control switch instruction, when the control switch instruction is executed, to a code rewriting process into a first object code when a program to be subjected to coverage measurement is compiled and the first object code is produced, the code rewriting process which rewrite the control switch instruction into a no-operation instruction;
produce, when the first object code is executed, a second object code such that when the control switch instruction in the first object code is executed, the executed control switch instruction to switch to the code rewriting process is rewritten into a no-operation instruction, and
calculate the coverage of the program to be subjected to coverage measurement, based on the first and second object codes.

16. The medium according to claim 15, wherein calculating the coverage includes comparing the first and second object codes.

17. The medium according to claim 15, wherein the control switch instruction is a software break instruction, and wherein the plurality of instructions cause the computer to execute, when the first object code is executed, the interruption process based on the inserted software break instruction, and to rewrite the software break instruction that has caused the interruption process into the no-operation instruction.

18. The medium according to claim 15, wherein the plurality of instructions causes the computer to specify basic blocks of a source code of the program when the first object code is produced, and to insert the control switch instruction into each specified basic block.

19. The medium according to claim 18, wherein calculating the coverage includes totaling the basic blocks, contained in the second object code, in which the control switch instruction remains, as unexecuted basic blocks, or totaling the basic blocks in which the control switch instruction is rewritten into the no-operation instruction, as executed basic blocks, and calculating the coverage based on the result of the total.

20. The medium according to claim 15, wherein the plurality of instructions cause the computer to specify, when the first object code is produced, a basic block from which a branch starts of a source code of the program and a basic block at which the branch ends of the source code, to insert basic blocks containing the control switch instruction to switch into the branch section between the specified basic blocks.
